(19) United States
(12) Patent Application Publication
(10) Pub. No.: US 2004/0054633 A1
(43) Pub. Date: Mar. 18, 2004

(54) Method and system for electronic order entry and automatic processing of photomask orders

(75) Inventors: Pascal Huyghe, Peynier (FR); William B. Knighton, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: DuPont Photomasks, Inc.

(21) Appl. No.: 10/607,944

(22) Filed: Jun. 27, 2003

Related U.S. Application Data
(60) Provisional application No. 60/392,567, filed on Jun. 28, 2002.

(51) Int. Cl. G06F 17/60

(52) U.S. Cl. 705/75

(57) ABSTRACT

A method and system for electronic order entry and automatic processing of photomask orders is disclosed. A method for order entry and processing in the manufacturing of a photomask component includes electronically receiving a product order information file. The product order information is automatically translated into a standard database format. The translated product order information file is then automatically processed using a rules engine to apply a predefined set of customer requirements to the product order information file such that the product order information is loaded into an order entry module. The order entry module is used to automatically create a production file necessary for the production of a photomask component according to the product order information file.

### RELATED APPLICATION

This application claims the benefit of U.S. Provisional Application Serial No. 60/392,567 entitled “Method and System for Electronic Order and Automated Processing,” filed by Huyghe et al. on Jun. 28, 2002.

### TECHNICAL FIELD OF THE INVENTION

The present invention relates in general to photolithography and more particularly to a method and system for electronic order entry and automatic processing of photomask orders.

### BACKGROUND OF THE INVENTION

As semiconductor device manufacturers continue to produce smaller devices, the requirements for photomasks used in the fabrication of these devices continue to tighten. Photomasks, also known as reticles or masks, typically consist of substrates (e.g. high-purity quartz or glass) that have a patterned layer (e.g., chrome or molybdenum silicide) formed on a substrate. The patterned layer includes a pattern representing a circuit image that may be transferred onto semiconductor wafers in a lithography system. As feature sizes of semiconductor devices decrease, the corresponding circuit images on the photomask also become smaller and more complex. Consequently, the technical specifications involved in ordering a photomask are increasingly complex. For example, one order file for a photomask may have thirty-five to forty pages of detailed technical specifications.

Currently, order entry and technical planning functions for photomask orders are performed manually for most orders and customers. Even where automation exists, such automation is customer specific, inflexible and subject to frequent failure. Presently, manual order entry and technical planning of photomasks carry a significant risk of human error, often cause delays due to extended order processing time (“cycletime”), and typically requires a significant number of personnel to prepare the order for manufacture.

One previous attempt to solve these problems resulted in the Semi P10 Standard promulgated by Semiconductor Equipment and Materials International (See www.semi.org). The Semi P10 standard is a data structure specification intended to: (1) facilitate the transmittal of mask order data between software systems; (2) allow automated order placement by mask customers; and, (3) allow automated processing of orders and automated delivery/processing of data.

By using the Semi P10 Standard, software written independently for either mask customers or mask shops should be able to communicate unambiguously with software written by other parties. The Semi P10 structure only defines the data format for the transmitted file (generally transmitted via an ASCII file). No particular database or programming language is specified by this standard.

The Semi P10 Standard has five key disadvantages: (1) lack of flexibility; (2) limited adoption by industry; (3) not easily human readable; (4) failure to specify a particular manner of use (i.e. programming language or database); and (5) failure to address other essential front-end operations.

FIG. 1 illustrates a type of Semi P10 processing as presently used for order processing of a photomask. Because the SEMI 10 Standard sets a data structure for the order entry, Semi File 100 received from a customer may be more complex than necessary. For example, the Semi P10 Standard establishes an industry-wide set of “tags” used to identify the particular contents of Semi File 1000. The tags must be used in a particular order and must represent the same elements in every order. As such, customers and mask shops are limited in how they can use Semi File 100. For some customers, this results in a submission of a significantly more complex file than is necessary for simple orders.

Use of the Semi P10 Standard requires a company to abandon long-used systems for submitting photomask orders or requires the customer to convert their photomask ordering output, often stored in a proprietary file format, into the Semi P10 Standard. As such, companies have demonstrated extreme reluctance in moving to the Semi P10 Standard.

Typically, when Semi File 100 is received at a mask shop, the file takes on two different paths. The first path is order preparation 101 that loads the photomask order into the manufacturing system so that the order can be written out in a clean room. Generally, order preparation 101 begins with pre-parser 102 that segments the order information to be directed to the appropriate parser programs. Parser programs, such as National 104, TI 106, IBM 108 and Motorola 110, convert the order information from the Semi P10 Standard format into a standard file type such as DPI Standard Semi File 112. Following another automated conversion process at block 114, DPI Standard Semi File 112 is converted into Demi File 116 that allows the order to be loaded into DPI's Oracle database 132 (i.e., eMask™).

A Semi File 100, in ASCII format, compliant with the Semi P10 Standard, often includes forty or more pages of single spaced text for a typical multi-layer order. While this may be satisfactory for an automated system, a mask manufacturer that does not utilize automation in receiving an order in Semi P10 Standard faces the daunting task of converting such extensive text into an order. As way of example, prior to use of the TI semi-parser (allowing automated use of the Semi P10 Standard for TI orders), customer service technicians often used a twenty-page “key” to manually decipher the file.

The second path is data preparation 118 that creates write ready information that goes out to the lithography tools for creating a photomask. Because data preparation 118 is typically a manual operation as compared with order preparation 101, it is often considered the critical path in photomask ordering.

Following some initial program routines such as FE Automation 120 and sBridge 122 that prepare data for a technical planner, the order file enters a manual operation of technical planning that selects appropriate processes and routines based on achieving the photomask as designated in the order. After parsing the data planning using CD Parser program 126, the data is converted into machine language via KMS Script 128 such that the data may be set for machine interface 130 and thus, loaded into DPI's Oracle database 132 (i.e., eMask™).

Other problems with the Semi P10 Standard are that instructions are not provided for how the standard is to be used. While this may have been intended to increase flexibility of the standard, instead it has increased confusion and limited adoption.

The Semi P10 Standard was designed as a way for mask customers and photomask manufacturers to communicate orders. The Semi P10 Standard fails to address any of the remaining steps of ordering validation and data preparation.

### SUMMARY OF THE INVENTION

In accordance with the teachings of the present invention, disadvantages and problems associated with entry and processing of order or other information necessary to describe a desired product, such as a photomask, are greatly reduced or eliminated.

In accordance with one embodiment of the present invention, a method for order entry and processing in the manufacturing of a photomask component includes electronically receiving a product order information file. The product order information file is automatically translated into a standard database format. A rules engine automatically processes the translated product order information by applying a predefined set of customer requirements to the product order information such that the product order information is loaded into an order entry module. The order entry module then automatically creates data necessary for the production of a photomask component according to the product order information file.

In accordance with another embodiment of the present invention, a system for electronic order entry and automatic processing of a photomask component includes a computer-readable medium and executable instructions encoded in the computer-readable medium. The executable instructions, when executed, direct a computer to perform operations including electronically receiving a product order information file in any format. The computer operations also include automatically translating the product order information file into a standard database format. Further, the computer operations include automatically processing the translated product order information file using a rules engine to apply a predefined set of customer requirements to the product order information file such that the product order information file is loaded into an order entry module. Lastly, the computer operations include the order entry module to automatically create data necessary for the production of a photomask component according to the product order information file.

In accordance with a further embodiment of the present invention, a method of manufacturing a photomask component includes electronically receiving a product order information file in any format. The method automatically translates the product order information file into an XML database format. The method automatically processes the XML database format using a rules engine to apply a predefined set of customer requirements to the product order information file such that the product order information is loaded into an order entry module. The method selects a template including customer specifications based on at least one criteria associated with the product order information file. The method validates the product order information by automatically comparing the product order information to the template to identify any inconsistencies. The method automatically creates data necessary for the production of a photomask component according to the product order information using the order entry module.

Important technical advantages of certain embodiments of the present invention include reduced cycle time required to manufacture a photomask by replacing the existing manual processes of receiving order information with an automated system.

Another technical advantage of certain embodiments of the present invention include a flexible system that receives order information in any of a plurality of different formats and produces an order entry in a standardized format.

A further important technical advantage of certain embodiments includes reducing errors resulting from the order process by reducing operator involvement.

All some or none of these technical advantages may be present in various embodiments of the present invention. Other technical advantages will be readily apparent to one skilled in the art from figures, descriptions, and claims.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 illustrates an example of an existing Semi P10 processing system;

FIG. 2 illustrates a cross-sectional view of a photomask assembly created based on an order entry and processing system or method according to teachings of the present invention;

FIG. 3 illustrates a flowchart for order entry and translation into a standard database format according to an example embodiment of the present invention;

FIG. 4 illustrates a flowchart for processing the standard database format and verifying the order entry data according to an example embodiment of the present invention; and

FIG. 5 illustrates a flowchart for a data preparation process for the production of a photomask according to an example embodiment of the present invention.

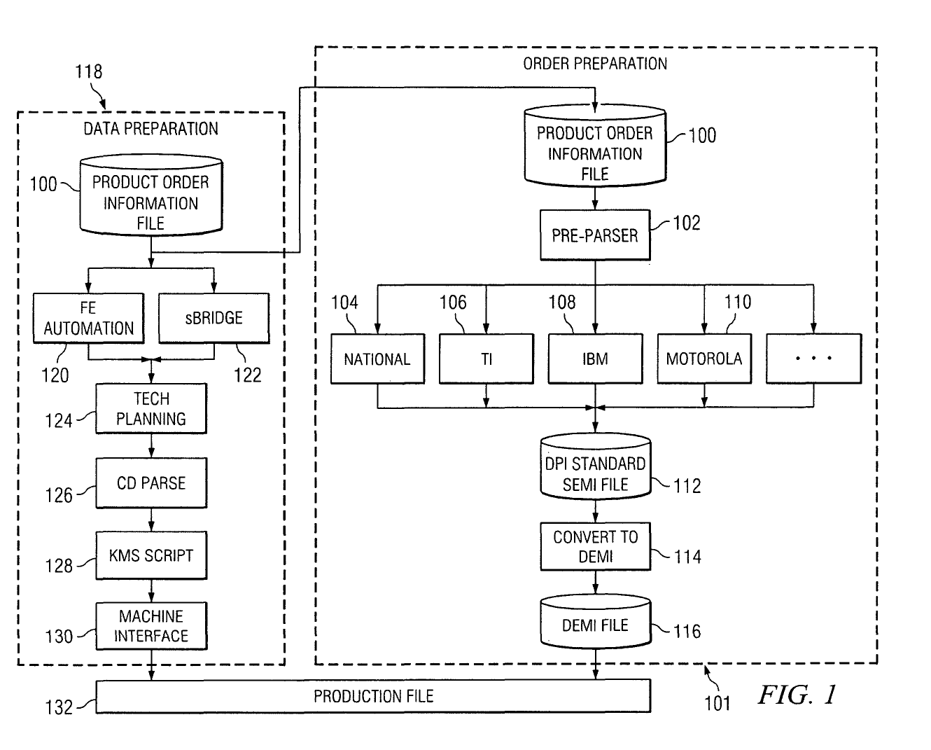

### DETAILED DESCRIPTION OF THE INVENTION

The present invention is described herein for use with a photomask ordering system. It will be understood to one skilled in the art that the original photomask order may be supplied by a customer or any other operator, human or non-human, capable of presenting the specific requirements for the photomask in an electronic format. It will also be understood to one skilled in the art that the general method and system of the present invention may be applicable in areas other than the production of photomasks.

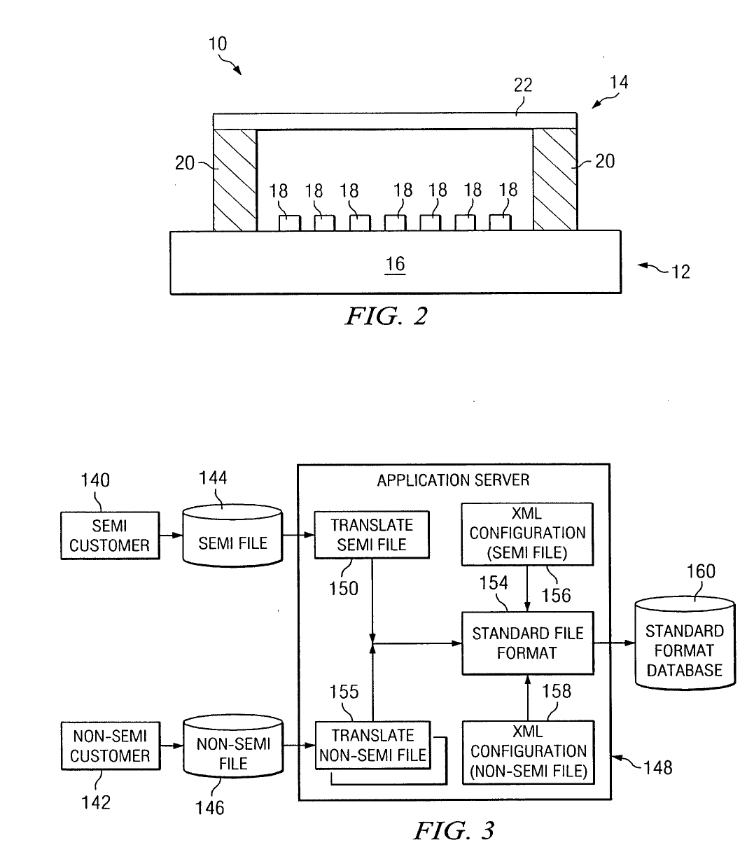

Preferred embodiments of the present invention and their advantages are best understood by reference to FIGS. 2 through 5, where like numbers are used to indicate like and corresponding parts.

FIG. 2 illustrates a cross-sectional view of photomask assembly 10 qualified with a prototype specification. Photomask assembly 10 includes photomask 12 coupled to pellicle assembly 14. Substrate 16 and patterned layer 18 form photomask 12, otherwise known as a mask or reticle, that may have a variety of sizes and shapes, including but not limited to round, rectangular, or square. Photomask 12 may also be any variety of photomask types, including, but not limited to, a onetime master, a five-inch reticle, a six-inch reticle, a nine-inch reticle or any other appropriately sized reticle that may be used to project an image of a circuit pattern onto a semiconductor wafer. Photomask 12 may further be a binary mask, a phase shift mask (PSM), an optical proximity correction (OPC) mask or any other type of mask suitable for use in a lithography system.

Photomask 12 includes patterned layer 18 formed on substrate 16 that, when exposed to electromagnetic energy in a lithography system, projects a pattern onto a surface of a semiconductor wafer (not expressly shown) Substrate 16 may be a transparent material such as quartz, synthetic quartz, fused silica, magnesium fluoride (MgF₂), calcium fluoride (CaF₂), or any other suitable material that transmits at least seventy-five percent (75%) of incident light having a wavelength between approximately 10 nanometers (nm) and approximately 450 nm. In an alternative embodiment, substrate 16 may be a reflective material such as silicon or any other suitable material that reflects greater than approximately fifty percent (50%) of incident light having a wavelength between approximately 10 nm and 450 nm.

Patterned layer 18 may be a metal material such as chrome, chromium nitride, a metallic oxy-carbo-nitride (M-O—C—N), where the metal is selected from the group consisting of chromium, cobalt, iron, zinc, molybdenum, niobium, tantalum, titanium, tungsten, aluminum, magnesium and silicon, and any other suitable material that absorbs electromagnetic energy with wavelengths in the ultraviolet (UV) range, deep ultraviolet (DUV) range, vacuum ultraviolet (VUV) range and/or extreme ultraviolet range (EUV). In an alternative embodiment, patterned layer 18 may be a partially transmissive material, such as molybdenum silicide (MoSi), which has a transmissivity of approximately one percent (1%) to approximately thirty percent (30%) in the UV, DUV, VUV and/or EUV ranges. In other embodiments, patterned layer 18 may any suitable number of material layers. The layers may be opaque, partially transmissive and/or transparent to the exposure wavelength of a lithography system.

Frame 20 and pellicle film 22 may form pellicle assembly 14. Frame 20 is typically formed of anodized aluminum, although it could alternatively be formed of stainless steel, plastic or other suitable materials that do not degrade or outgas when exposed to electromagnetic energy within a lithography system. Pellicle film 22 may be a thin film membrane formed of a material such as nitrocellulose, cellulose acetate, an amorphous fluoropolymer, such as TEFLON® AF manufactured by E. I. du Pont de Nemours and Company or CYTOP® manufactured by Asahi Glass, or another suitable film that is substantially transparent to wavelengths in the UV, DUV, EUV and/or VUV ranges. Pellicle film 22 may be prepared by a conventional technique such as spin casting.

Pellicle film 22 protects photomask 12 from contaminants, such as dust particles, by ensuring that the contaminants remain a defined distance away from photomask 12. This may be especially important in a lithography system. During a lithography process, photomask assembly 10 is exposed to electromagnetic energy produced by an energy source within the lithography system. The electromagnetic energy may include light of various wavelengths, such as wavelengths approximately between the I-line and G-line of a Mercury arc lamp, or DUV, VUV or EUV light. In operation, pellicle film 22 is designed to allow a large percentage of the electromagnetic energy to pass through it. Contaminants collected on pellicle film 22 will likely be out of focus at the surface of the wafer being processed and, therefore, the exposed image on the wafer should be clear. Pellicle film 22 formed in accordance with the teachings of the present invention may be satisfactorily used with all types of electromagnetic energy and is not limited to lightwaves as described in this application.

Photomask assembly 10 includes a variety of photomask components used to construct the finished product. Given the considerable amount of selection and specification available for each photomask component, order entry and processing of photomask assembly 10 may be very detailed and customer specific. As shown below, a method for order entry and processing of a photomask component may be used to manufacture at least one component of photomask assembly 10 or several photomask assemblies 10.

FIG. 3 illustrates a flowchart for order entry and translation into standard database format 160. Automated ordering of at least one component of photomask assembly 10 generally requires a customer or other operator to submit a product order information, customarily referred to as “paperwork,” to a mask shop in electronic form. Typically, the paperwork is received via electronic mail and file transfer protocol.

As such, customers generally fall into two different categories. The first category are those customers that have elected to follow the Semi P10 standard, generally referred to as Semi Customer 140, who submit the product order information according to the Semi P10 standard, namely Semi File 144. The second category of customers are those who do not follow the Semi P10 Standard and are generally regarded as Non-Semi Customer 142 who will transmit the product order information in non-Semi format 146. Semi File 144 and Non-Semi File 146 may generally be referred to as a product order information file.

Whether the file follows the Semi P10 Standard or not, the product order information file is received by the photomask shop, typically at application server 148. Example file formats of product order information include, but are not limited to, a spreadsheet file such as Microsoft Excel™, a word processing file such as Microsoft Word™, an ASCII text file, or a postscript file. Once received, the order information is automatically translated into a standard file format 154, such as an extensible markup language (XML) format. The translation of the product order information may be a completely “hands off” operation, and thus occurs automatically upon submission of order information, as shown in block 150 and block 152.

In one example embodiment, the translation occurs by way of an XML “schema.” XML schemas express shared vocabularies and allow machines to carry out defined rules. An XML schema provides the means for defining the structure, content and semantics of XML documents. One embodiment of the present invention requires development of a unique mask-manufacturing schema.

The translation process may employ a customer and fab specific XML “configuration” that, using the mask-manufacturing schema above, provides the logic for translating the customer information into standard database format 160, such as a propriety DPI semi standard database format. By automating this process, the recent order information file can be translated into standard database format 160 in less than one minute.

In certain embodiments, the XML configurations are limited to one configuration per customer and/or fab combination. The XML configuration may preferably be further specifically defined for use with either Semi file 144 or non-Semi File 146, Semi File 156 or XML configuration for Non-Semi File 158 respectively.

Once the translation is complete, the product order information file is stored in standard database format 160. Standard database format 160 includes a standard semi database format and in some embodiments, also includes customer specific information not included in the semi standard format such as additional functionality required by customers not covered by the Semi P10 Standard. Standard database format 160 is available to other software applications (eMask™, sBridge, data fracture engines, etc.) that may selectively utilize or manipulate customer order specific information.

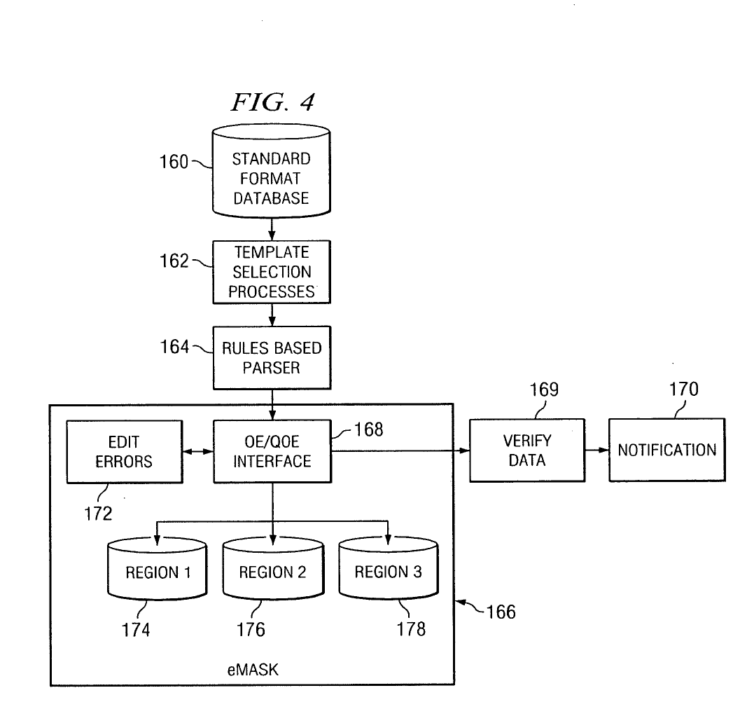

FIG. 4 illustrates a flowchart for processing standard database format 160 and verifying the order entry data. Once the customer's particular electronic submission is converted into standard database format 160, the product order information is loaded into order entry module 168 of eMask™ process module 166 automatically without requiring prompting on the part of an operator. This automation replaces the existing manual order entry function. There are two sub-processes that are preferably included in the automation.

One sub-process of eMask™ process module 166 is automated template selection process 162 that allows for between fifty to eighty percent (50-80%) of an order to be completed before the order arrives, based on consistencies with the customer's specification. However, when an order is manually entered, the operator must select a template for each order based on at least one of the following criteria: customer, fab, product type, description, and template grade. Under automated template selection process 162, the appropriate template is selected by the system automatically based on the above criteria using “rules based parsing” process 164, preferably employing an XML format. Further, automated template selection process 162 may further include identifying which region the mask is to be manufactured in to support selection of region-specific templates.

In a preferred example embodiment, rules based parsing process 164 begins as a result of a triggering event such as the receipt of a customer order. The rules applied to a customer order following rules based parsing process 164, typically, are based in part on customer definitions of how to process his or her data received in the customer order. Depending on the customer or the complexity of the order, each customer may have few as twenty-five rules established for his or her orders while other customers may have over 150 rules. Generally, the rules are defined independently of the customer, such that, the rules can be associated with a customer in a particular sequence. For example, when calculating a grate for a customer, an address rule must first be applied to the data in order to attain address information that is used with a subsequent rule to calculate the correct grate.

Once the correct template is selected, the order may be validated or verified via an automated comparison between the template and the product order information, which had previously been converted into standard database format 160, as shown in block 169. Should the system identify an inconsistency between what was anticipated by the template with what was submitted electronically as part of the order, the system preferably notifies the operator(s) via both email and an input to the work-in-progress screen, as shown in block 170. If no differences between the order and the template are identified, then the system may send a “successful upload” notice via email, for example, to the appropriate operator(s) and releases the order to technical planning and the data preparation process. The released order may cause the order entry module to automatically create a production data file for the production of a photomask component according to the product order information file. Further, each order that is released may be based on a specific region of use, such as regions 174, 176, 176 which may include, for example, Asia, Europe or North America, respectively and stored or maintain in standard database format 160 for such use. Generally, the use of the automated process permits an order entry process to have an error rate of less than 0.5 percent.

However, if an inconsistency is determined such that the operator is notified of the error, the operator may then move the process to a manual operation, as shown in block 172. In the manual operation, the operator may either select a different template to compare to the order data or may revise the order data to be consistent with the template. In either event, the process allows for manual intervention to resolve problems or inconsistency that the system cannot resolve.

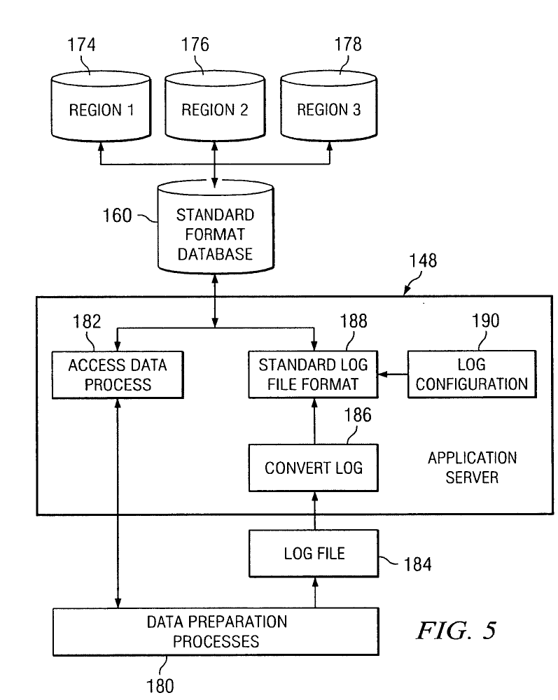

FIG. 5 illustrates a flowchart for data preparation process 180 for the production of at least one component of photomask assembly 10. Following the construction of standard database format 160 based on a product order information file, order entry and processing may be moved to data preparation process 180.

For many customers that provide sufficient information, the invention also presents a fully “hands off” process for data preparation process 180. Data preparation process 180 may include creation of lithography instructions (job deck creation), technical planning and pattern formatting (data fracturing). Data preparation process 180 utilizes and accesses standard database format 160 established at an order entry and translation process, as shown in block 182. The data preparation process manipulates standard database format 160 using application server 148 via an identical XML schema and a similar XML template structure as above. Typically, the process is able to prepare a production data file for the production of a photomask component in less than approximately one hour.

For example, log file 184 may be fractured data created in block 180. Log file 184 may be transformed into standard log file format 188, which may include a standard XML format, via block 186. Similarly, standard log file format 188 may be configured using XML log configuration 190, which are similar to XML configurations as described above. Once the translation of log file 184 is complete, the information may be maintained in standard database format 160 for use by the different manufacturing regions.

Although the present invention has been described in detail, it should be understood that various changes, substitutions, and alterations can be made without departing from the spirit and scope of the invention as defined by the appended claims.

What is claimed is:

1. A method for order entry and processing in the manufacturing of a photomask component, comprising:
electronically receiving a product order information file for the photomask component;
automatically translating the product order information file into a standard database format;
automatically processing the translated product order information file using a rules engine to apply a predefined set of customer requirements to the product order information file such that the product order information file is loaded into an order entry module; and
using the order entry module to automatically create for the production of the photomask component according to the product order information file.

2. The method of claim 1, further comprising
automatically selecting a template including customer specifications based on at least one criteria; and
validating the product order information file by automatically comparing the product order information file to the template to identify any inconsistencies.

3. The method of claim 2, further comprising based on the validation of the product order information file, notifying an operator of identified inconsistency.

4. The method of claim 3, wherein the notification comprises an email notification.

5. The method of claim 2, further comprising following the identification of at least one inconsistency, manually selecting a template for a product order information file.

6. The method of claim 2, further comprising the at least one criteria selected from the group consisting of customer, fabrication, product type, template grade and template region.

7. The method of claim 1, wherein the product order information file is in a semi-file based format.

8. The method of claim 1, wherein the product order information file is in a non-semi-file based format.

9. The method of claim 1, wherein the standard database format comprises a standard semi database format.

10. The method of claim 9, wherein the standard database format further comprises a customer specification information not included in the semi standard format.

11. The method of claim 1, further comprising translating the product order information into a standard file format.

12. The method of claim 11, further comprising configuring the product order information in extensible markup language (XML) format according to an XML configuration.

13. The method of claim 12, wherein the XML configuration includes specification information.

14. The method of claim 1, wherein the production data file for the production of a photomask component includes lithography instructions and patterning information.

15. The method of claim 1, wherein creating the production data file for the production of the photomask component further comprises using the product order information file to select a customer-specified order template for use in preparing the production data file for the production of the photomask component.

16. The method of claim 1, further comprising translating the product order information into a standard database format in less than approximately one minute.

17. The method of claim 1, further comprising preparing the production data file for production of the photomask component in less than approximately one hour.

18. The method of claim 1, further comprising maintaining the data necessary for production of the photomask component in the standard database format usable by a plurality of manufacturing sites.

19. The method of claim 1, further comprising the method having an order entry process with an error rate of less than 0.5 percent.

20. A system for electronic order entry and automatic processing of a photomask component order comprising:
a computer-readable medium; and
executable instructions encoded in the computer-readable medium, the executable instructions, operable to direct a computer to:
electronically receive a product order information file;
automatically translate the product order information file into a standard database format;
automatically process the translated product order information file using a rules engine to apply a predefined set of customer requirements to the product order information file such that the product order information file is loaded into an order entry module; and
automatically create a production data file for the production of the photomask component according to the product order information file.

21. The system of claim 20, the executable instructions further operable to:
select a template including customer specifications based on at least one criteria; and
validate the product order information file by automatically comparing the product order information file to the template to identify at least one inconsistency.

22. The system of claim 21, further comprising the executable instructions further operable to, notify an operator whether any inconsistencies were identified during the validation operation.

23. The system of claim 21, further comprising the executable instructions further operable to facilitate the manual selection of a template for a product order information file following the identification of at least one inconsistency between the product order information file and the selected template.

24. A method of manufacturing a photomask component, comprising:
electronically receiving a product order information file;
automatically translating the product order information file into an XML database format;
automatically processing the XML database format using a rules engine to apply a predefined set of customer requirements to the product order information file such that the product order information file is loaded into an order entry module;
selecting a template including customer specifications based on at least one criteria indicated in the product order information file;
validating the product order information by automatically comparing the product order information to the template to identify any inconsistencies; and
using the order entry module to automatically create a production data file for directing the production of a photomask component according to the product order information.

25. The method of claim 24, further comprising electronically notifying an operator whether any inconsistencies were identified during the validation of the product order information file.

26. The method of claim 25, wherein electronically notifying comprises generating an e-mail notification.

27. The method of claim 24, further comprising manually selecting a template for a product order information following the identification of at least one inconsistency.

28. The method of claim 24, wherein the production data file includes lithography instructions and patterning information.
